(19) United States
(12) Patent Application Publication
(10) Pub. No.: US 2003/0071798 A1
(43) Pub. Date: Apr. 17, 2003

(54) System and method for transmitting, receiving, and generating digital ink from triangulation data of a transponder-stylus

(76) Inventors: Ehud Baron, Haifa (IL); Victor Korsenski, Haifa (IL)

Correspondence Address: SQUIRE, SANDERS & DEMPSEY L.L.P, 600 HANSEN WAY, PALO ALTO, CA, 94304-1043, US

(21) Appl. No.: 10/131,725

(22) Filed: Apr. 23, 2002

Related U.S. Application Data
(60) Provisional application No. 60/285,681, filed on Apr. 23, 2001.

(51) Int. Cl. G09G 5/00

(52) U.S. Cl. 345/179

(57) ABSTRACT

A system for generating digital ink from triangulation data of a stylus comprises an electromagnetic radiation source capable to emit electromagnetic pulses; a first and a second ultrasound detector separated from each other by a known distance; a timer coupled to the radiation source, the first detector, and the second detector, and capable to measure a first elapsed time between emission of an electromagnetic pulse from the radiation source and detection of an ultrasound wave at the first detector, and further capable to measure a second elapsed time between emission of the electromagnetic pulse from the radiation source and detection of an ultrasound wave at the second detector; and a triangulation engine coupled to the timer and the radiation source, the engine capable to instruct the source to emit a plurality of radiation pulses, to triangulate the position of an ultrasound transponder over time based on the first elapsed time, the second elapsed time and the known distance between detectors, and to generate characters based on the triangulation data.

### PRIORITY REFERENCE TO PRIOR APPLICATIONS

This application claims benefit of and incorporates by reference patent application serial No. 60/285,681, entitled “METHOD AND SYSTEM FOR A SELF-IDENTIFYING PEN,” filed on Apr. 23, 2001, by inventors Ehud Baron and Victor Korsenski.

### TECHNICAL FIELD

This invention relates generally to transponders, and more particularly, but not exclusively, provides a system and method for a self-identifying electronic pen for use in a handwriting input system.

### BACKGROUND

Conventional handwriting input systems use a stylus and a touch screen or similar device for input. For example, in personal digital assistants (PDAs), such as a Palm® handheld device, a user enters data via writing on a touch screen with a stylus. The disadvantage of conventional handwriting input systems is that they may require touch screens for input of data, which can be large and bulky.

### SUMMARY

The present invention provides a system for a transponder that can be used in a handwriting input system. The system comprises a stylus, which includes an infrared detection device communicatively coupled, via a switch, to an ultrasound-generating device. The switch is located in a tip of the stylus such that when pressure is applied to the tip, the detection device, when detecting a radiation, sends a command to the ultrasound-generating device to generate an ultrasound.

A position sensing system, comprising a first and a second ultrasound detector separated by a pre-defined distance, an electromagnetic radiation source, and a timing device coupled to the detectors and source, can calculate the location of the stylus by measuring the time it takes to receive an ultrasound pulse at the first and second ultrasound detectors from the time of transmitting the electromagnetic radiation. Further, the position sensing system may be communicatively coupled to a computer or other processing device capable display, based on triangulation data from the position sensing system, motion of the stylus as digital ink.

The present invention further provides a method for a handwriting input system using a self-identifying stylus. The method comprises: sending, from a position sensing system to a transponder, an electromagnetic pulse; measuring the time it takes to receive an ultrasound pulse at two ultrasound detectors from the time of transmitting electromagnetic pulse; calculating the position of the transponder based on the measured times; repeating the above steps over a period of time corresponding to a user writing with the self-identifying stylus; and displaying motion of the transponder over time as digital ink on a display device.

The system and method may therefore advantageously enable a user to input handwriting into a device without the need for a touch pad or similar mechanism.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a position-sensing system and a self-identifying transponder according to an embodiment of the invention;

FIG. 2 is a block diagram illustrating an embodiment of the self-identifying transponder of FIG. 1;

FIG. 3 is a circuit diagram the transponder;

FIG. 4 is a circuit diagram of another embodiment of a transponder;

FIG. 5 is a block diagram of another embodiment of a transponder;

FIG. 6 is a circuit diagram of another transponder according to an embodiment of the invention;

FIG. 7 is a circuit diagram of the transponder of FIG. 6 showing more detail of a mode decoder;

FIG. 8 is a chart depicting the timing of various signals for the embodiment of FIG. 6;

FIG. 9 is a block diagram of the position sensing system of FIG. 1;

FIG. 10 is a circuit diagram of a position sensing system according to another embodiment of the invention;

FIGS. 11A, 11B and 11C depicts the appearance of typical waveforms at the locations indicated A, B, and C, respectively in FIG. 10;

FIG. 12 depicts the data protocol sent from the microcontroller of FIG. 10 to the processor of FIG. 10 in an embodiment of the invention;

FIG. 13 depicts the directivity of an exemplary ultrasound transducers used in a transponder;

FIG. 14 depicts the directivity of an exemplary detector in a position sensing system;

FIG. 15 depicts the overlap of the zones of acceptance of two compression wave detectors;

FIG. 16 depicts the compression wave detectors detecting ultrasound compression waves emitted by a transponder;

FIG. 17 is a block diagram of a computer capable to generate digital ink based on data received from a position sensing system; and

FIG. 18 is a flowchart illustrating a method for displaying digital ink on a display.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

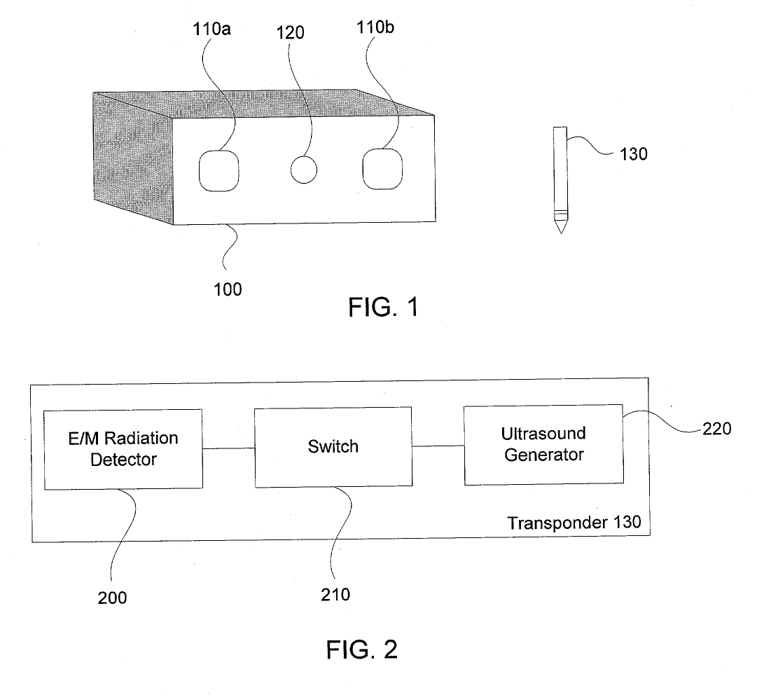

FIG. 1 is a block diagram illustrating a position-sensing system 100 and a self-identifying transponder 130 according to an embodiment of the invention. In an embodiment of the invention, transponder 130, as will be discussed further in conjunction with FIG. 2, detects electromagnetic radiation emitted from system 100 and, in response, emits an ultrasound pulse. Transponder 130 may be housed in a stylus, writing implement, scanner, bar code reader, laser pointer, mouse, joystick, surgical instrument or any other device.

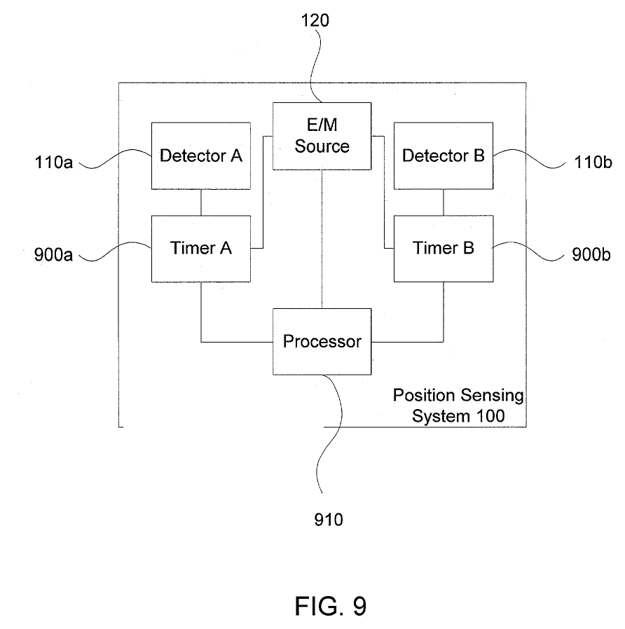

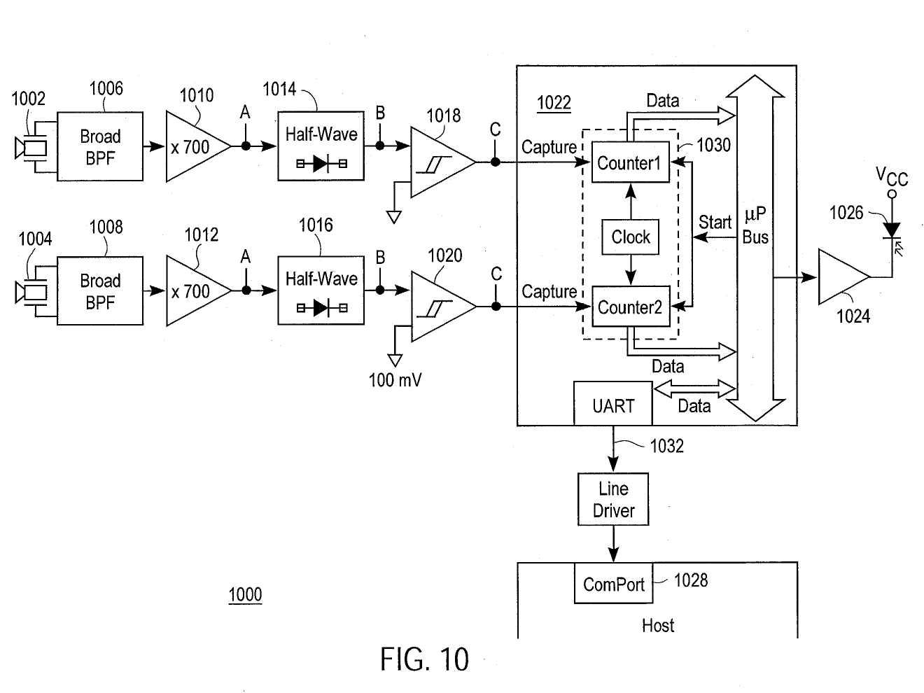

System 100, as will be discussed further in conjunction with FIG. 9, comprises a housing including an electromagnetic source 120. The housing of system 100 further includes two ultrasound detectors 110a and 110b with detector 110a being separated from detector 110b by a predefined distance. A timing device (not shown) measures the elapsed time between emission of an electromagnetic pulse by the electromagnetic source and the reception of an ultrasound pulse at the detectors 110a and 110b from the transponder 130. Based on the elapsed time, the position of the stylus can be calculated, as will be discussed further in conjunction with FIG. 10.

FIG. 2 is a block diagram illustrating an embodiment of the transponder 130 (FIG. 1). In an embodiment of the invention transponder 130 comprises an detector 200 that can detect a first type of energy, such as electromagnetic (EM) radiation, an optional switch 210, and an generator 220 that can emit a second type of energy, such as ultrasound, communicatively coupled together in series. In one embodiment, detector 200 detects EM radiation emitted by EM source 120 of system 100. Further, detector 200 may include an IRDA compliant IR receiver, such as the Infineon IRMS5000, which is a highly sensitive IR receiver with protection from ambient daylight and other sources of light. Further, the IRMS5000 may have a low jitter of leading front of synchronization IR pulses of less than +/−5 s. In another embodiment of the invention, a light pipe (not shown) may be coupled to the detector 200. The light pipe may be made of a transparent plastic especially suited to absorb IR light from the source 120 of the system 100 and deliver the IR light to the to detector 200.

Switch 210, which is communicatively coupled to detector 200, may be actuated by events including, but not limited to, pressure from an actuator (not shown) communicatively coupled to the switch 210, a predetermined sequence of EM pulses as detected by detector 200, the passage of a preset amount of time, heat detection, pen tilt and/or angle detection, or other techniques. Switch 210 may also be configured so that it controls operation of detector 200 or generator 220 by, for example, controlling the supply of power to them. This configuration may be used to limit the power consumed by the transponder 130 to only those instances when it is desired to have transponder 130 in an enabled state. Further, in another embodiment of the invention, switch 210 may control transmission of a signal from detector 200 to generator 220. In one embodiment of the invention, switch 210 may be a membrane SPST switch, such as one commercially available from Nelson Nameplate Company. The membrane SPST switch may have an extremely low travel with calibrating breaking and back force of 10-15 grams.

Generator 220 is communicatively coupled to detector 200 via optional switch 210. If transponder 130 does not include switch 210, then generator 220 may be directly communicatively coupled to detector 200. Embodiments of generator 220 may include an ultrasonic transducer, such as one made using a piezoceramic element to generate an ultrasonic signal. In one embodiment of the invention, generator 220 includes a PVDF ultrasonic transmitter having a center frequency of about 39+/−2 KHz, and may be available commercially from MSI. Further, the transmitter may be a circular omni-directional diagram pattern transducer or a unidirectional transducer. In addition, a transformer (not shown) may be coupled to the transmitter for transducer excitation. The transformer may have a primary winding inductance of about 6-7? H and a secondary output winding inductance of 28 mH with a resistance of 130 Ohms to produce an excitation voltage of 140V at 5V power supply. The transformer may be commercially available from Coilcraft.

In an embodiment of transponder 130 without switch 210, detector 200 detects an EM pulse from system 100. Detector 200 then contacts generator 220, which sends an ultrasound pulse to the system 100. In one embodiment, the ultrasound pulse may have a frequency range between 1 KHz to 500 KHz. In another embodiment, the frequency range may be between 10 KHz and about 100 KHz. In another embodiment, the frequency range may be between 30 KHz and 50 KHz. In another embodiment of the invention, the ultrasound pulse has a frequency of 40 KHz.

In an embodiment in which transponder 130 includes switch 210, generator 220 generates an ultrasound pulse only when switch 210 is actuated. In one embodiment of the invention, a pressure sensitive actuator (not shown), which may be coupled to the housing of transponder 130, may actuate the switch 210. In one embodiment, transponder 130 is housed in a stylus and the pressure sensitive actuator may be coupled to a tip of the stylus. Applying pressure to the tip of the stylus would therefore actuate the pressure sensitive actuator, thereby activating switch 210. In another embodiment, switch 210 may coupled to the other types of actuators, such as a heat sensitive actuator, which would activate the switch 210 upon sensing heat, such as the heat from a hand.

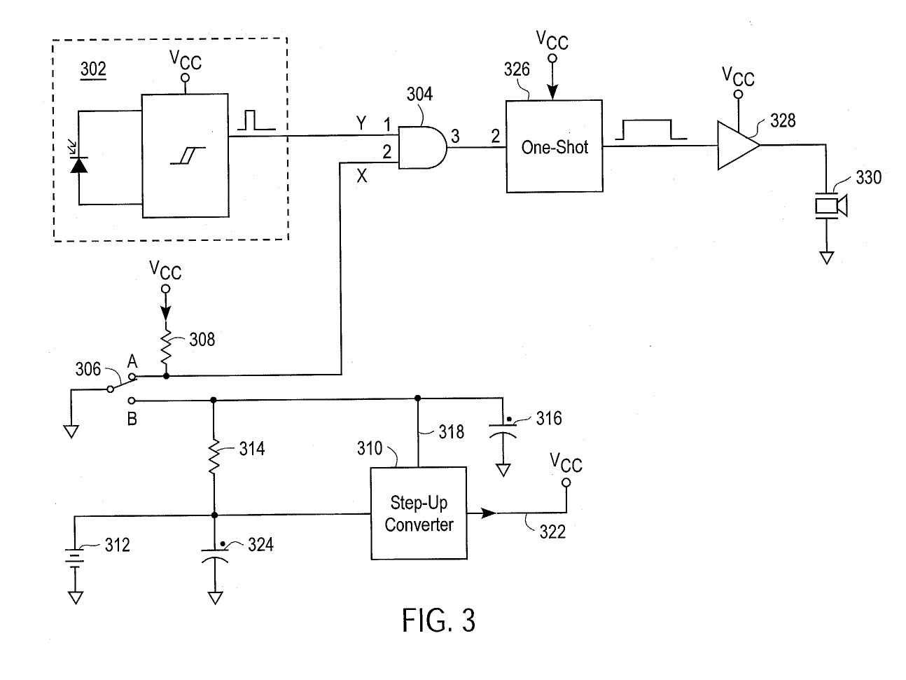

FIG. 3 is a circuit diagram of a transponder 300, which includes infrared (IR) detector 302. The output of detector 302 is input into the first input of AND gate 304. The second input of the AND gate 304 is coupled to switch 306 and through pull resister 308 to Vcc.

In the embodiment of FIG. 3, switch 306 is closed, and therefore, transponder 130 is a non-enabled state, which is the default state of transponder 130 to thereby enabling conservation of power. In this position the input to AND gate 304 from switch 306 is connected to ground (i.e., logical 0) and pulses output from detector 302 are not transmitted through AND gate 304. When switch 306 is in the open position (i.e., when transponder 130 is enabled), the contact of the switch 306 connects ground to contact B and the second input to AND gate 304 is at about Vcc (i.e., logical 1).

When switch 306 is in the enabled state, connected to contact B, optional voltage converter 310 may be activated. Converter 310 converts the voltage output of power supply 312, which may be a battery, to a voltage level suitable to run the components of transponder 130. In one embodiment, when switch 306 is in the non-enabled position, power supply 312 discharges through pull up resistor 314 until capacitor 316 is charged up. Power supply 312 is also connected to input 320 of converter 310. When capacitor 316 is charged up, connection 318 of converter 310 is at approximately the same voltage as power supply 312, causing voltage converter 310 to shut down. In this shut down mode, little or no current is drawn from power supply 312, enabling the useful lifetime of power supply 312to be extended.

When switch 306 is in the enabled state, the voltage on connection 318 is brought to ground and converter 310 is activated and converts the voltage of power supply 312 to a voltage of Vcc (e.g., 5 Volts) at output 322. Optional bypass capacitor 324 can be added to improve performance of the voltage converter 310. When switch 306 is switched back to a non-enabled state, capacitor 316 again charges up through pull up resistor 314. The time constant of this charging circuit can be chosen to set the period of time between the switching of switch 306 from the enabled to non-enabled state, and the halting of the converter 310.

In an embodiment in which a voltage supply of sufficient voltage to directly operate the components of transponder 130 is available, voltage converter 310 may be eliminated. In this embodiment, switch 306 is configured to prevent voltage from reaching one or more of the components of the transponder 130 when it is in a non-enabled state, and to allow voltage to reach the components of transponder 130 when it is in an enabled state.

Referring back to FIG. 3, when switch 306 is in the non-enabled state, output pulses from detector 302 are not transmitted through AND gate 304. When switch 306 is in the enabled state, output pulses from detector 302 are transmitted through AND gate 304 to generator 326, which converts an input pulse of variable duration into a pulse of predetermined duration suitable to operate driver 328 and ultrasonic transducer 330.

Optionally, transducer 330 may be coupled to a horn or other impedance matching element to more efficiently couple the transducer to air. See, for example, the discussion in “A High Efficiency Transducer for Transmission to Air,” by J. Kritz, IRE Trans. Ultrason. Eng., Vol. UE-8, March 1961, pp. 14-19, which is hereby incorporated by reference.

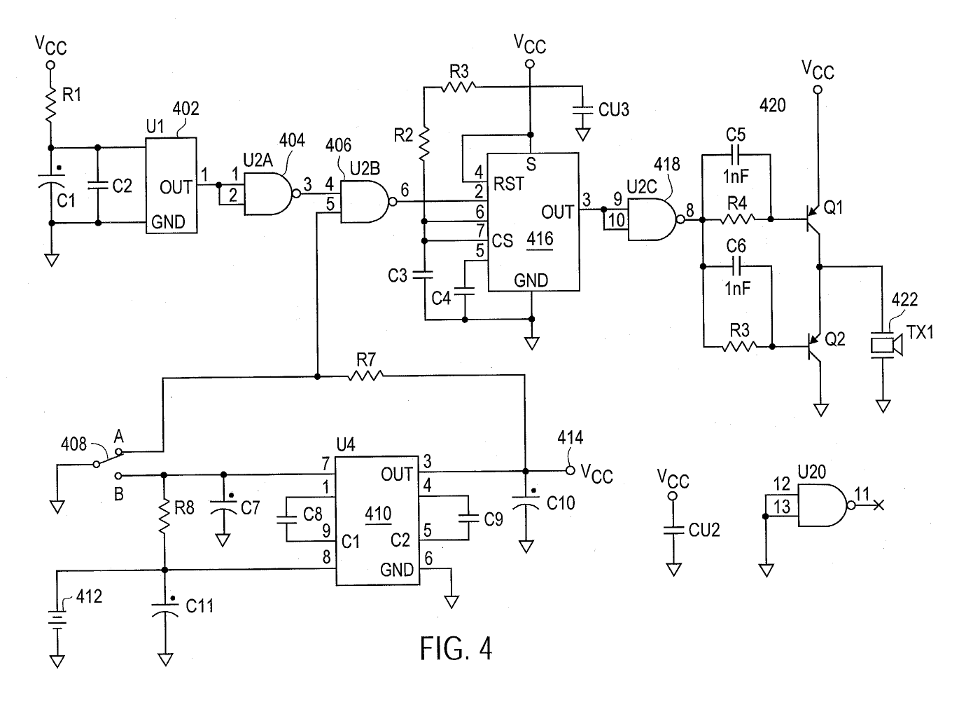

FIG. 4 is a circuit diagram of another embodiment of a transponder 400. In this embodiment, transponder 130 includes an infrared detector 402, which may be a TFDU4100 manufactured by Telefunken Semiconductor. The output of detector 402 is input in NAND gate 404 configured to function as an inverter. The output of NAND gate 404 is then input into the first input of NAND gate 406. The second input to NAND gate 406 is from terminal A of switch 408 connected through a 150 K-Ohm resistor to the Vcc output of voltage converter 410.

In the non-enabled position, switch 408 is connected to terminal A and the second input to NAND gate 406 is held at ground (logical 0) preventing any pulses from detector 402 from passing though NAND gate 406. When switch 408 is in the enabled position, voltage converter 410 is activated and the voltage output from battery 412 is converted into voltage Vcc at output 414 driving the second input of NAND gate 406 to a voltage near Vcc (logical 1), thereby allowing pulses from detector 402 to pass through NAND gate 406 to a one-shot generator 416.

In an embodiment of the invention, generator 416 may be a LMC555 biased to convert the input pulse into an output pulse of about 12.5 microseconds. This output pulse is fed through NAND gate 418 wired as an inverter to provide a fast driving signal that is then sent into driver circuit 420 and ultrasound transducer 422.

Driver circuit 420 is configured so that the amplitude of the leading part of the generated ultrasound wave is as high as possible. Since the transducer 422 may have a high Q, the driver 420 may cause ringing in the transducer 422, which may be reduced by having the lower transistor of driver circuit 420 short the transducer 422 to ground just after initial excitation of the transducer 422.

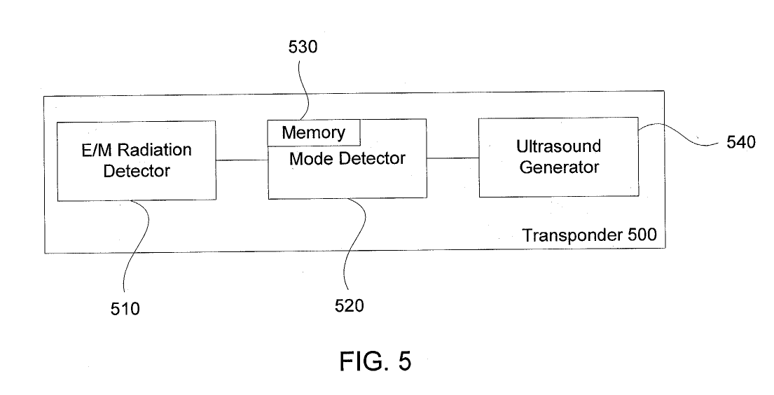

FIG. 5 is a block diagram of another embodiment of a transponder 500, which includes a radiation detector 510, a mode detector 520, and an ultrasound generator 540. In an embodiment of the invention, transponder 500 may also include a switch, which may be substantially similar to switch 210 (FIG. 2). Further, in an embodiment of the invention, detector 510 and generator 540 may be substantially similar to detector 200 (FIG. 2) and generator 220, respectively.

In an embodiment of the invention, mode detector 520 may also include a memory 530, such as FLASH memory or other memory device. Memory 530 stores data that can be selectively transmitted upon request. Mode detector 520 may operate in two modes: data mode and a draw mode. In data mode, mode detector 520 transmits selected data from memory 530 to generator 540, which then encodes and/or converts the selected data into compression waves. In the draw mode, mode detector 520 transmits a signal to generator 540 each time detector 510 receives an EM signal; therefore, in effect, transponder 500 acts substantially similar to transponder 130.

In one embodiment of the invention, EM detector 510 places mode detector 520 into data mode by sending a signal to mode detector 520 upon receipt of a data mode EM signal. In another embodiment of the invention, a user can place the mode detector 520 into data mode by pressing an actuator coupled to the mode detector 520.

Examples of data that memory 530 may store include user identification information, payment information such as debit or credit card data, passwords, and/or any other data. Accordingly, in an embodiment of the invention, a user may pay be able to pay for a purchase from a vending machine or a supermarket checkout by enabling the data mode of the mode detector 520 via an optional actuator on the transponder. Alternatively, payment data may be sent in response to receipt of a data signal mode EM signal from a vending machine or other device. In another embodiment, payment can be made by enabling the data mode of the mode detector 520 and entering a PIN into a machine and/or signing the user's name with the transponder 500. In another embodiment of the invention, enabling the data mode of mode detector 520 may enable other devices, such as opening doors, starting an automobile, etc.

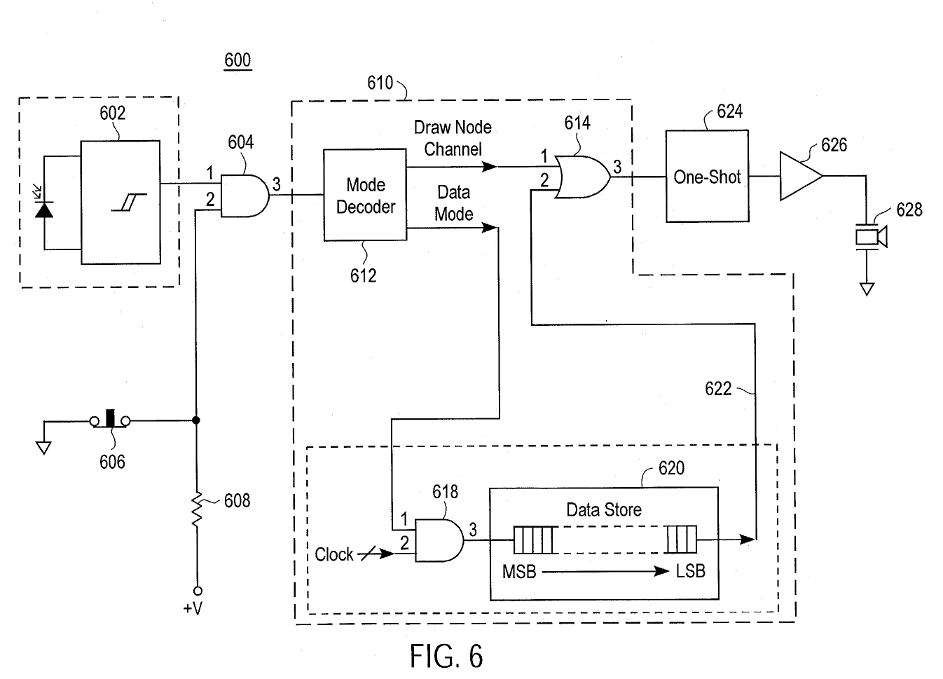

FIG. 6 is a circuit diagram of transponder 600 according to another embodiment of the invention. Transponder 600 may be houses in a stylus or other device. IR detector 602 is coupled to the first input of AND gage 604. The second input of AND gate 604 is coupled to ground through switch 606 and positive voltage through resistor 608 such that when switch 606 is closed, the second input AND gate 604 is at ground. Switch 606 may be placed on an accessible portion of the housing. For example, if transponder 600 is located within a stylus, switch 606 may be placed on a tip of the stylus so that when the tip is pressed against a surface, the switch is opened. Alternatively, the switch 606 may be placed on a side of the stylus so that a user may actuate the switch 606.

When switch 606 is open, a logical 1 is present at the second input to AND gate 604 and signals generated by detector 602 are transmitted through AND gate 604. The output of AND gate 604 is fed into mode detector 610, which include a mode decoder 612. The mode decoder 612 is coupled a draw mode connection to a first input of OR gate 614 and coupled by a data mode connection to data storage and output system 616. Data storage and output system 616 is coupled to the second input of OR gate 614. Data storage and output system 616 includes AND gate 618 to data store 620. The first input of AND gate 618 is the data channel output from mode decoder 612, and the second input to AND gate 618 is from a clock (not shown). In the data mode, a logical 1 is put on the data mode channel 622 and the clock signal is allowed through AND gate 618 and into data store 620. The clock signal then clocks out pre-stored data from data store 620 on data channel 622 to OR gate 614. In data mode, the draw mode channel is kept at a logical 0 level while data is being clocked out of data store 620. In draw mode, the data mode channel 622 is kept at logical 0 preventing data from being clocked out of data store 620 and the output from AND gate 604 is passed to OR gate 614 through mode decoder 612 along the draw mode channel and then into one shot generator 624. In one embodiment, data store 620 may include a Microchip PIC16c508 micro-controller.

The output of OR gate 614 is coupled to one shot generator 624, which converts an input pulse of variable duration into a pulse of predetermined duration suitable to operate ultrasound transducer 628. The output of one shot generator 624 is input into driver 626, which drives transducer 628.

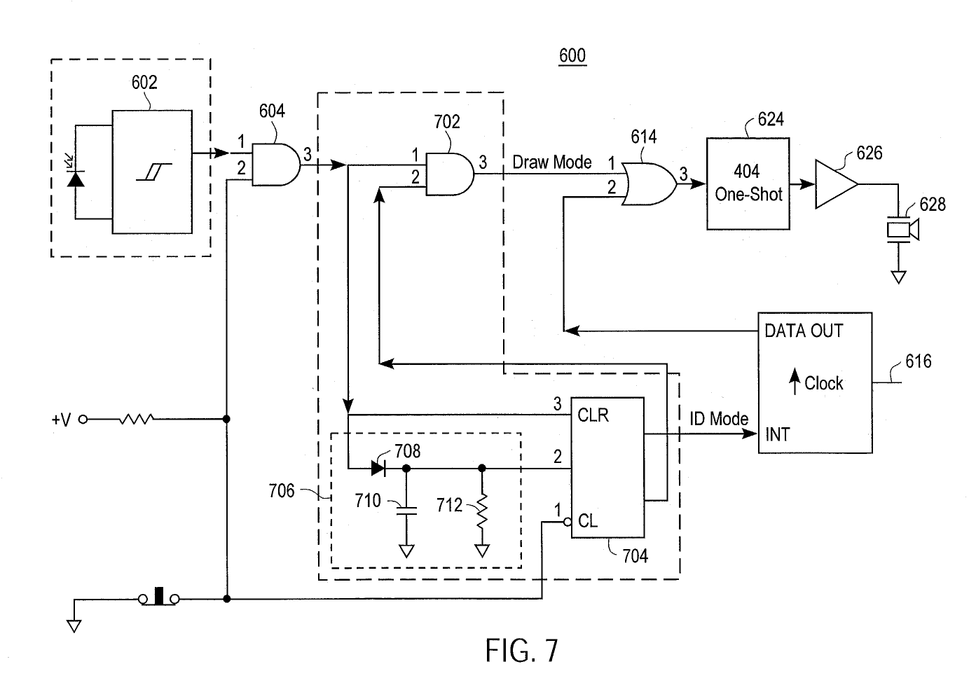

FIG. 7 is a circuit diagram of transponder 600 showing more detail of mode decoder 612. In this embodiment, the output from AND gate 604 is input into the first input of AND gate 702, the clock input of D flip flop 704, and peak hold circuit 706. Diode 708, capacitor 710 and resistor 712 are chosen to hold a signal level fro a predetermined period of time which is shorted than the period between signals ordinarily received by transponder system 600 in the draw mode. The Q output of D flip flop 704 is input into data storage and output system 716 and the not Q output is input in the second input of AND gate 702.

A user may initiate a data transmission session by placing transponder 600 in a position so that IR detector 602 can receive a data mode signal, which may have been transmitted from system 100, as will be discussed further below. In another embodiment, a user can initiate a data transfer mode by pressing a data mode switch located on the exterior of the transponder 600 housing.

If the data mode is initiated, transponder 600 sends the data (or a subset of the date) stored in data store data store 620 to the ultrasound transducer 628, which outputs it as a continuous serial bit stream in asynchronous format. A time interval (“bit cell”) is reserved for each bit. If the corresponding data bit is 1, the ultrasound burst is sent at the time period corresponding to the origin of the bit cell and if the corresponding data bit is 0, then the ultrasound burst is not sent in the time period for the data cell.

In one embodiment, the data pulse signal for placing the transponder 600 into data mode comprises a series of two EM pulses separated by less than the hold time of peak hold circuit 706. Peak hold circuit 706 may have a time constant of about 25 microseconds while the data mode pulse is comprises of two pulses separated by about 7 microseconds. If switch 606 is closed when the data mode signal is received, this signal, in the form of the two closely spaced pulses, appears on the output of the AND fate 604 and passed to mode decoder 612, which includes AND 712, D flip flop 704 and peak hold circuit 706.

The first pulse passes AND gate 702 and excited one-shot generator 624 through OR gate 614. Simultaneously, this pulse is applied to peak hold circuit 716, which stores the 1 voltage level for an amount of time, and to clock synchronous input of D flip flop 704, which is controllable by low to high transition. The output of peak hold circuit 706 is applied to D control input of D flip flop 704. When the first high to low transition occurs on the clock input, D flip flop 704 stays clear. The 1 level, stored by the peak hold circuit 706, slowly decays to 0 with the time constant as set by the components (e.g. approximately 25 μs in one embodiment), the level on D input is 1 and high to low transition on the clock input sets the D flip flop 704. The level of the Q output toggles low to high and initiates operation of data storage and output system 516 (which can be a micro-controller in one embodiment). Data storage and output system 616 then clocks out data stored in the memory in data storage and output system 616 using an internal clock (not shown).

The level on non-Q output of the D flip flop disables the pulses from AND gate 604 to pass through gates 702 and 614 to one shot generator 624. The short pulse which appears on the output of OR gate 614 does not affect the one shot generator 624 because it is configured so that it is not retriggerable during 12.5 Ps from the origin of the first pulse of data mode signal sequence.

Data storage and output system 616 starts to output the data stored in its onboard memory. Each clock transition shifts one bit of the memory contents (least significant first to master significant bit in one embodiment) to one shot generator 624 through OR gave 614. for each bit of data which is a 1, data storage and output system 616 sends an output pulse of width 4 μs through to trigger the one shot generator 624 which generates an output pulse of 12.5 μs to excite the transducer 628.

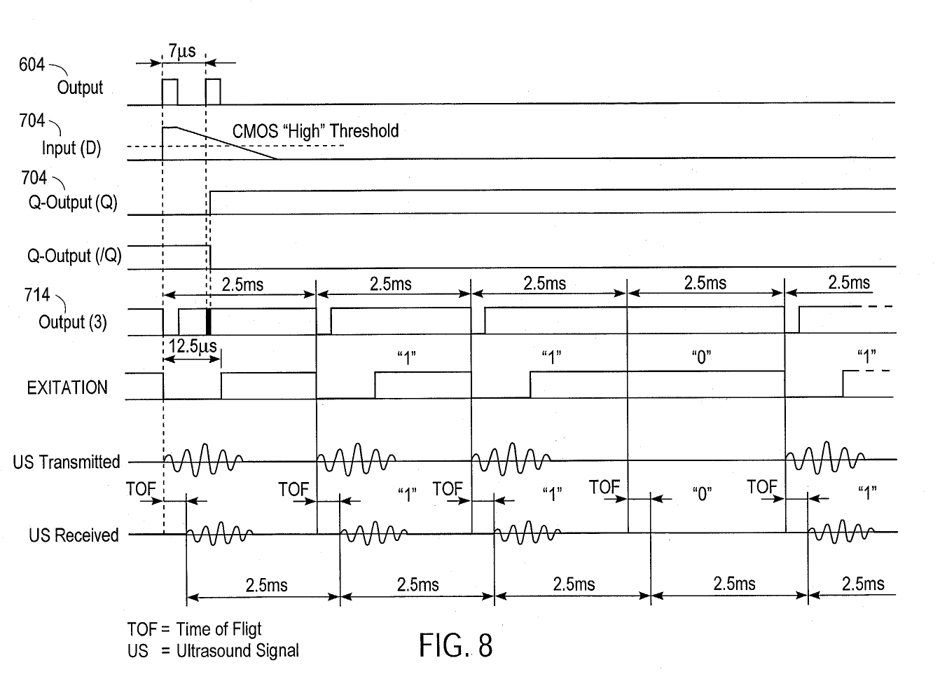

In one embodiment, each bit cell is 2.5 ms long (i.e., the data is sent at the rate of 400 bps) and the data is a 16 decimal number represented in BCD format, encoded by the 64 bit binary value. Transmission may be protected by a checksum, calculated by summing of all the significant bits of an ID value modulo 2 powered by 8. The ID, containing 72 bits of data and checksum, may be sent during 0.18 s at a data rate of 400 bps. FIG. 8 is a chart depicting the timing of various signals for this embodiment.

FIG. 9 is a block diagram of the position sensing system 100 of FIG. 1. System 100 includes a first compression wave detector 110a, a second compression wave detector 110b, timers 900a and 900b, and processor 910. Detectors 910a and 910b are capable to detect ultrasound waves emitted from a transponder, such as transponders 130, 300, 400, 500, and/or 700. Detectors 110a and 110b may also include a horn or other impedance matching structure to enable the detectors 110a and 110b to more efficiently detect the compression waves. Detector 110a is communicatively coupled to timer 900a and detector 110b is coupled to timer 900b. In turn, timers 900a and 900b are communicatively coupled to processor 910. EM source 120 is communicatively coupled to times 900a and 900b and processor 910.

Timers 900a and 900b may include any device that can measure elapsed time including, but not limited to, counters communicatively coupled to a clock. In another embodiment, timers 900a and 900b may be implemented as a single timer capable to measure two or more elapsed times. Processor 910 may include any processor including, but not limited to, a microprocessor, a computer, dedicated logic, an ASIC, etc. In one embodiment, timers 900a and 900b are incorporated into processor 910.

In operation, processor 910 sends a signal to EM source 120, which generates an EM pulse upon receipt of the signal. The processor 910 signal also starts timers 900a and 900b. When a transponder receives the EM pulse, it emits an ultrasound wave in return, which is received by detectors 110a and 110b. When detector 110a detects a pulse, timer 900a stops. When detector 110b detects the pulse, timer 900b stops. Processor 910 determines the elapsed time on times 900a and 900b between the emission of the EM pulse and detection of the ultrasound wave at the detectors 110a and 110b. Using these elapsed times, a known distance between the detector 110a and 110b, and the known velocity of the ultrasound waves, processor 910 determines the relative position of the transponder using triangulation methods.

FIG. 10 is a circuit diagram of position sensing system 1000 according to an embodiment of the invention. System 1000 includes a first ultrasound detector 1002 and a second ultrasound detector 1004. In one embodiment of the invention, detectors 1002 and 1004 may have center frequency of 40+/−1 KHz with bandwidth of +/−2 KHz at a 6 dB level. Detectors 1002 and 1004 may include Murata MA40S4R detectors and/or piezo ceramic receivers from Ceramic Transducer Design.

Detectors 1002 and 1004 are connected with the same polarity so that an increase in pressure on the detectors results in a positive voltage output. Detectors 1002 and 1004 are connected, respectively, to band pass filter 1006 and 1008, each with a pass band of about 300 Hz to about 60 KHz. In another embodiment of the invention, band pass filters 1006 and 1008 may have a pass band between 100 Hz to 500 KHz, or any range subsumed therein.

The outputs of band pass filters 1006 and 1008 are input respectively into amplifiers 1010 and 1012 with a gain of about 700. In one embodiment of the invention, the amplifiers include Texas Instruments' RC4558. The gain factor on the amplifiers 1010 and 1012 may be set to any value as required by system 1000. In an embodiment of the invention, the gain on amplifiers 1010 and 1012 is dynamically adjusted to keep a characteristic (e.g., peak, RMS value, mean value, etc.) of output signal from each of the amplifiers 1010 and 1012 at the same value during repeated uses of the system 1000, thereby aiding in reproducibility and accuracy of detection.

The outputs of amplifiers 1010 and 1012 are then input into half-wave rectifiers 1014 and 1016 respectively, and then into the inverting input of comparators 1018 and 1020 respectively. The non-inverting input of comparators 1018 and 1020 are connected to ground or near ground voltage such as about 100 millivolts.

The output of comparators 1018 and 1020 are sent to microcontroller 1022 and input into timer system 1030 of microcontroller 1022, which is coupled to IR driver 1024, which is coupled to IR LED 1026.

Microcontroller 1022 is also coupled by connection 1032 to processor 1028, which can be any type of processor including, but not limited to, a microprocessor, an ASIC, a DSP, or other processing device. Further, processor 1028 may be part of a personal computer, mobile phone, personal digital assistant, or any device having a processor. In another embodiment of the invention, the processing performed by microcontroller 1022 and processor 1028 may be combined into a single processor. Connection 1032 may be any type of connection capable to communicatively couple microcontroller 1022 and processor 1028, including a network connection, such as the Internet, fiber optic connection, wireless techniques, etc.

Timer system 130 includes a first counter and a second counter connected respectively to the output of comparators 1019 and 1020. The counters are also connected to a clock. The frequency of the clock will determine the timing accuracy of the system 1000, and therefore, spatial accuracy of the system 1000. In one embodiment of the invention, the clock rate may be about 1.536 MHz, which gives a time resolution of about 651 nanoseconds and a spatial resolution of about 0.22 mm.

During operation of system 1000, microcontroller 1022 generates a trigger pulse, which causes LED 1026 to emit an IR pulse and begins the counting of both counters in timer system 1030. These counters count at the clock rate set by the clock in timer system 1030. In another embodiment of the invention, the counters begin counting after a predetermined time delay from the emission of the IR pulse.

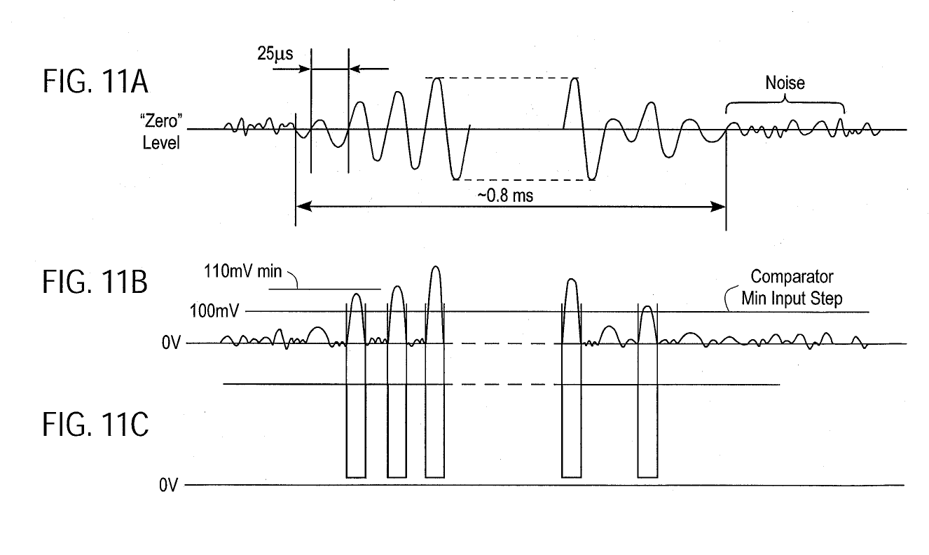

The IR pulse emitted by LED 1026 is received by a transponder, such as transponder 130 (FIG. 2), which in turn emits an ultrasound compression wave. Ultrasound detectors 1002 and 1004 then detect the ultrasound compression wave. FIGS. 11A, 11B and 11C depicts the appearance of typical waveforms at the locations indicated A, B, and C, respectively in FIG. 10.

FIG. 11A depicts a typical signal after amplification. In this example, the signal has a duration of about 0.8 milliseconds and period of about 25 microseconds. The signal and noise oscillate about a centerline voltage level which can be set by system 1000 to be any level, such as 0 volts or 2.5 volts.

FIG. 11B depicts a typical waveform after passing through the rectifiers 1014 and 1016. In one embodiment, comparators 1018 and 1020 are set to detect signals over 100 millivolts. At this threshold setting, comparators 1018 and 1020 do not detect noise, but do detect the second positive peak of the signal, since it surpasses this threshold. The threshold can be adjusted subject to the noise present in the system 1000 and the desired cycle number of the received signal to be detected. The output switches from high to low whenever the input signal crosses the comparator threshold.

The output of the comparators is sent into the capture input of the counters and the first pulse out of each comparator stops their respective counter. Each counter thus measures the time elapsed between the trigger pulse causing the LED emission and the reception by the respective detectors of an ultrasound compression wave that generates an electrical signal greater than the detection threshold of the detector. In one embodiment of the invention, microcontroller 1022 does not enable the capture inputs to the counters until a predetermined time has passed. The predetermined time corresponds to a predetermined distance between the device generating the compression wave and the compression wave detectors 1002 and 1004. This time period can also be used to prevent detections of reflections of compression waves from objects or other surfaces.

This predetermined time can be used to reduce the number of bits required to be sent from the counters if the approximate position of the transponder generating the ultrasound compression wave is known (e.g., from previous operations of the system 1000). This predetermined time can be dynamically changed as the position of the transponder changes. In another embodiment of the invention, the clock rate can be increased to provide a more accurate determination of the position of the transponder.

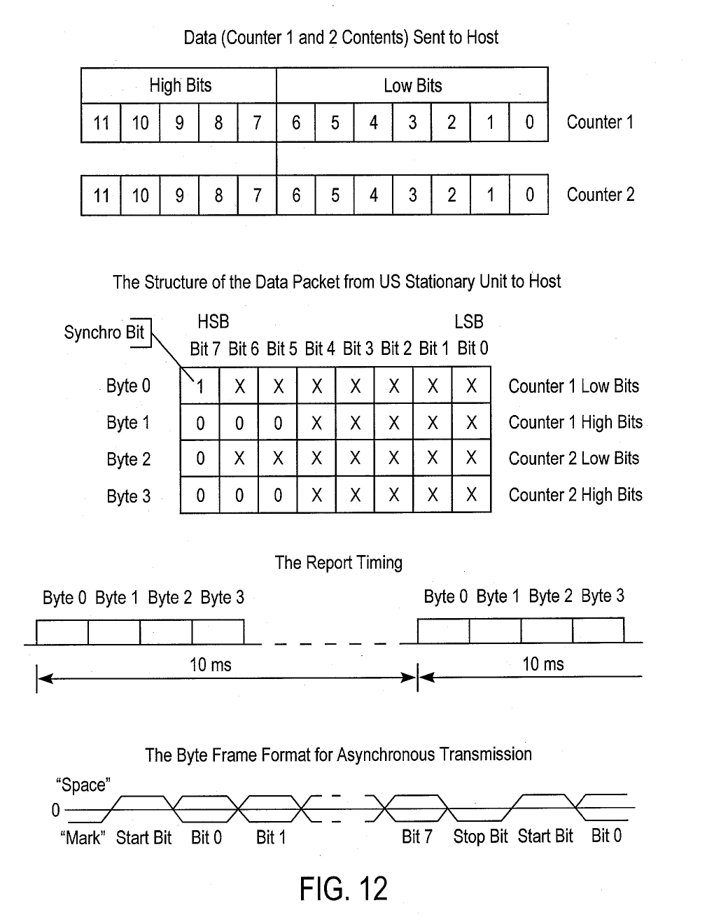

FIG. 12 depicts the data protocol sent from the microcontroller 1022 to the processor 1028 in an embodiment of the invention. The output of the counters representing the time of flight of the compression wave has 12 bit resolution. The content of the counters is sent from the microcontroller 1022 to the processor 1028 in a four-byte package. Byte 0 contains synchro-bit (bit 7) set to indicate which counter the data is from. The rest of byte 0 and the LSBs of byte 1 contain the contents of one of the counters, while bytes 2 and 3 contain the contents of the other counter. In one aspect of the invention, processor 1028 processes the time of flight data using the known speed of ultrasound compression waves in air to determine the position of the transponder using triangulation.

The system 1000 can be configured to repeat the LED signaling, time of flight measurement process at any desired rate. In one embodiment, the process is repeated at a rate between 1 Hz and 10 KHz, or any range subsumed therein. In another embodiment, the rate may be between 100 Hz and 200 Hz. In another embodiment of the invention, the rate may be depend on the location of objects that may cause spurious reflections of compression waves that may be detected by system 1000. These effects may warrant a decrease in the rate. However, the rate must be high enough to sample the motion of the transponder.

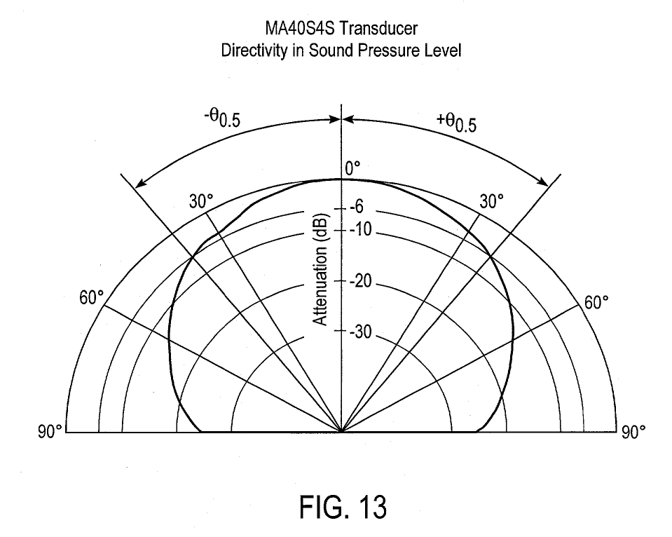

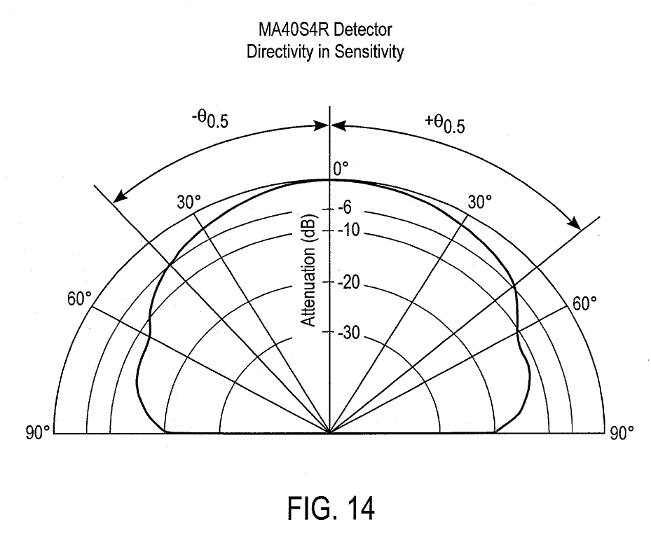

FIG. 13 and 14 depict the directivity of exemplary ultrasound transducers used in a transponder and detectors in a position sensing system, respectively. The plots are done in relative scale and the location of maximum signal strength is at a 0 dB reference. It is noted that the higher the frequency of the ultrasound, the more quickly it attenuates in air. Additionally, since high frequency ultrasound waves have a shorter wavelength, they may be more useful in enabling more accurate determination of the location of the transponder by the system 1000. Therefore, there is a trade off between attenuation of the ultrasound wave and accuracy of location determination. Accordingly, ultrasound in the frequency range of 5 KHz to 500 KHz, or any subset subsumed therein, may be used.

It is noted that the speed of the propagation of the compression waves varies with temperature, humidity, altitude, and other factors. Such factors typically only cause a variation of less then +/12% in the speed of the wave propagation. Such an offset, along with other constant offsets, may be used to determine an absolute position of the transponder. However, if only relative position is required, such offsets may not be required. Application of the invention that require only relative position include handwriting detection, drawing, computer interface navigation, etc.

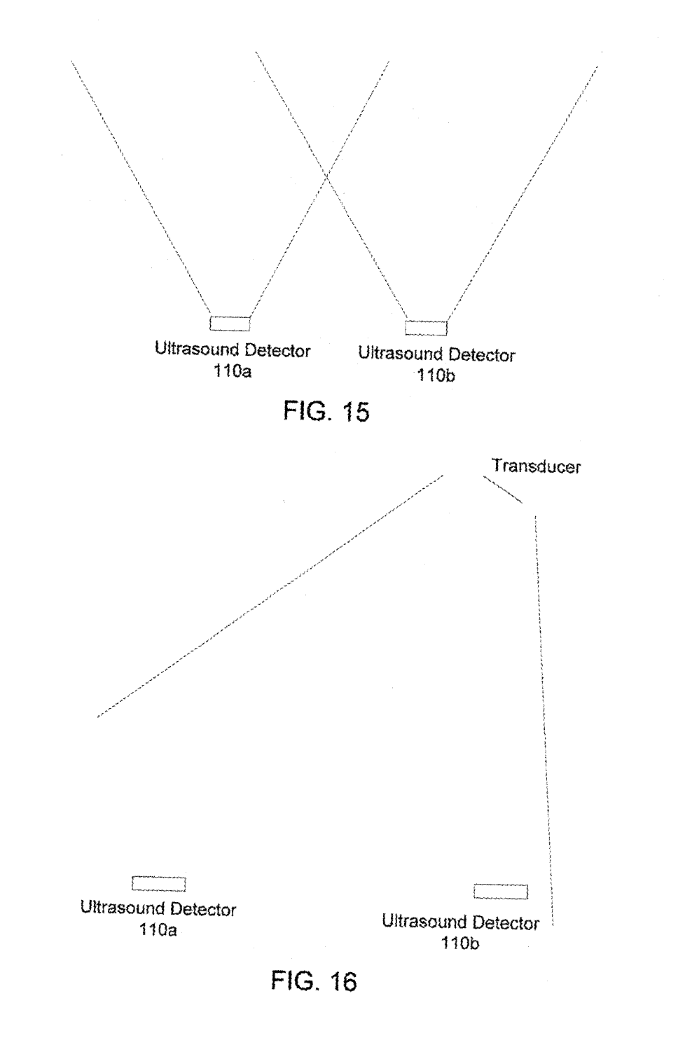

As depicted in the embodiment of the invention of FIG. 15, the directivity patterns of the transponder and compression wave detectors used in the system 1000 will affect the area over which this embodiment of the invention will be able to operate. As depicted in FIG. 15, the system 1000 will only operate if the transponder is within the area of overlap of the zones of acceptance of the two compression wave detectors.

As depicted in FIG. 16, the transponder must generate a signal that can be detected by compression wave detectors. Thus, the transponder must have a large enough directivity angle so that both detectors can be illuminated by the compression waves at once. If the transponder has a directivity of less than +/−90 degrees, there will be a dead spot between the two compression wave detectors, the size of which is related to one or more of the separations of the two compression wave detectors, the angle of acceptance of the two compression wave detectors, and the directivity of the device for generating compression waves. The dead spot can be reduced or eliminated by angling the two compression wave detectors toward each other so that their cones of acceptance overlap at any desired point or region; increasing the directivity angle of the transponder; and/or other techniques. In one embodiment, the separation between the compression wave detectors is 55 mm and the dead zone is about 80 to 140 mm.

Other factors that may determine the useful area overlap between the two compression wave detectors include user-related factors, such as user rotation of the transponder.

In an embodiment of the invention in which transponder 500 is used in conjunction with a position sensing system, such as system 1000, the position sensing system may send a data mode pulse to the transponder when the transponder is placed in a certain location. Alternatively, the position sensing system may send the data mode pulse upon receiving a command from a user or other device. For example, a user may make a purchase from a vending machine, which includes a position sensing system. Upon the user entering a purchase request (such as selecting the type of soda), the position sensing system would send a data mode pulse. Upon receipt of the financial data from the transponder, the position sensing system will process payment and the vending machine will release the soda to the user. The position sensing system or other device that receives the data may also check the data for accuracy using a checksum or other technique. A draw mode signal can then be sent to the transponder or the transponder may automatically return to draw mode after a pre-specified amount of time. If the data was not received correctly, the position sensing system can resend the data mode pulse to the transponder.

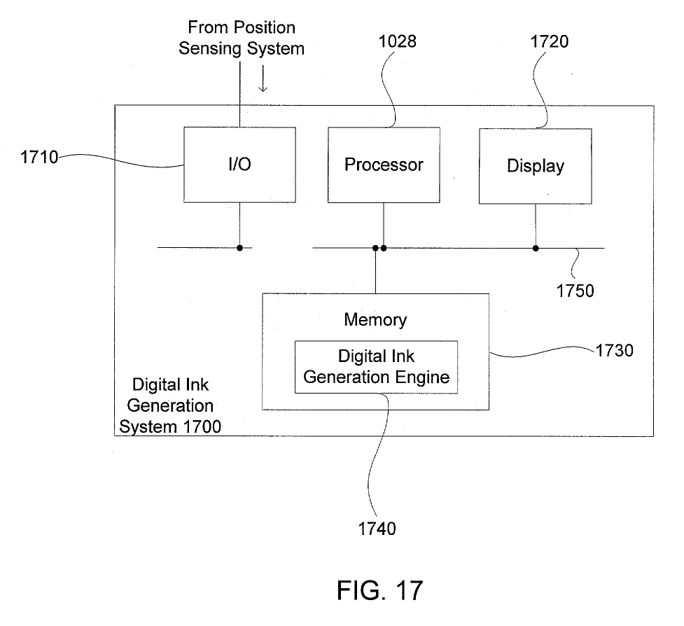

FIG. 17 is a block diagram of a digital ink generation system 1700 capable to generate digital ink based on data received from a position sensing system System 1700 may be a PDA, mobile phone, desktop computer, or any other device having a processor. Further, in another embodiment, the functions of system 1700 may be combined into a position sensing system, thereby eliminating the need for two processors. System 1700 comprises Input/Output (“I/O”) interface 1710; processor 1028, display 1720; and memory 1730, all coupled together via system bus 1750. I/O 1710 couples system 1700 to a position sensing system, such as system 1000, via a connection, such as connection 1032. Memory 1730 may comprise a single read and write capable memory device, or it may comprise multiple memory devices including a Hard Drive, RAM, ROM and/or any other memory devices. Further, memory 1730 includes a digital ink generation engine 1740 capable to generate digital ink using triangulation algorithms based on data received from a position sensing system. Accordingly, any motions made by a transponder, such as transponder 130, will be reproduced exactly on display 1720 as digital ink and further may be stored in memory 1730. In another embodiment of the invention, memory 1730 may further include a character recognition engine capable to generate alphanumeric characters based on the digital ink.

Processor 1028 can include an Intel Pentium® processor or any other processor capable of executing engine 1740. Display 1720 displays characters generated by character generation engine 1740. In addition, system 1700 may comprise other devices (not shown), such as an input device that may comprise a keyboard, mouse, trackball, or other devices or any combination thereof.

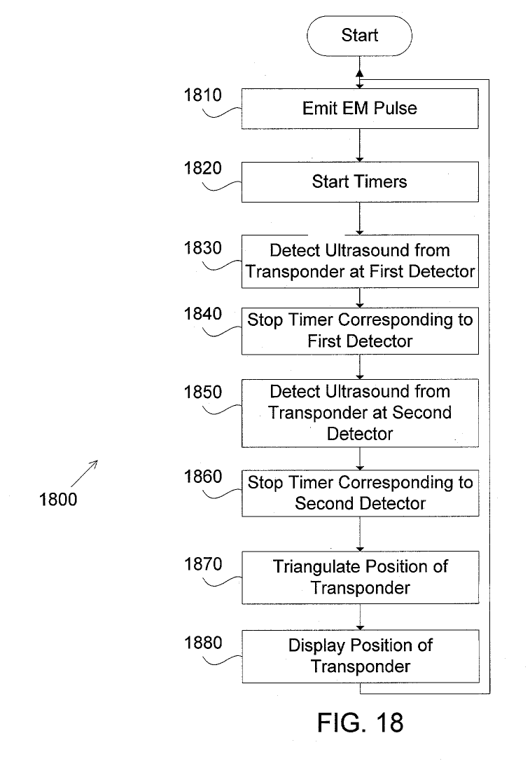

FIG. 18 is a flowchart illustrating a method 1800 for displaying digital ink on a display. In an embodiment of the invention, position sensing system 100 in core unction with digital ink generation system 1700, may perform method 1800. First, an electromagnetic pulse is emitted (1810) by, for example, EM source 120. Timer A 900a and timer B 900b are then started (1820). An ultrasound is then detected (1830) at a first detector, such as detector A 110a, a corresponding timer, such as timer A 900a, is stopped (1840). The ultrasound is then detected (1850) at a second detector, such as detector B 110b, and a corresponding timer, such as timer B 900b, is stopped (1860). The position of a transponder that emitted the ultrasound is then triangulated (1870) based on the known distance between detectors and time of flight of the ultrasound to the two detectors as measured by the timers. The position of the transponder, relative to the detectors, is then displayed (1880) on a display. The above-mentioned process is then repeated at regular intervals so as to display motion of the transponder on a display, i.e., to display digital ink.

The foregoing description of the preferred embodiments of the present invention is by way of example only, and other variations and modifications of the above-described embodiments and methods are possible in light of the foregoing teaching. For example, the transponder may emit an ultrasound pulse upon receipt of an EM signal that is not in the Infrared spectrum. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A transponder, comprising:
a detector capable to detect a first type of energy; and
a generator coupled to the detector capable to send a wave of a second type of energy when the detector detects the first type of energy.

2. The transponder of claim 1, wherein the first type of energy includes electromagnetic radiation.

3. The transponder of claim 2, wherein the electromagnetic radiation includes light.

4. The transponder of claim 3, wherein the light has a frequency in the infrared spectrum.

5. The transponder of claim 2, wherein the electromagnetic radiation includes radiation in the spectrum of radio frequencies.

6. The transponder of claim 1, wherein the second type of energy is sound.

7. The transponder of claim 6, further comprising a light pipe coupled to the detector.

8. The transponder of claim 6, wherein the sound is ultrasound.

9. The transponder of claim 8, wherein the ultrasound has a frequency of between about 40 KHz and 100 KHz.

10. The transponder of claim 8, wherein the generator includes a piezoceramic crystal.

11. The transponder of claim 8, an impedance matching element coupled to the generator.

12. The transponder of claim 1, further comprising a switch coupled to the detector and generator, the switch capable to control operation of the detector.

13. The transponder of claim 12, wherein the switch is actuated by pressure.

14. The transponder of claim 12, wherein the switch is actuated by heat.

15. The transponder of claim 12, wherein the switch is actuated by tilt of the transponder.

16. The transponder of claim 1, wherein the transponder is disposed within a stylus.

17. A position sensing system, comprising:
an electromagnetic radiation source capable to emit electromagnetic pulses;
a first ultrasound detector;
a second ultrasound detector separated from the first ultrasound detector by a known distance;
a timer coupled to the radiation source, the first detector, and the second detector, the timer capable to measure a first elapsed time between emission of an electromagnetic pulse from the radiation source and detection of an ultrasound wave at the first detector, the timer further capable to measure a second elapsed time between emission of the electromagnetic pulse from the radiation source and detection of an ultrasound wave at the second detector; and
a triangulation engine coupled to the timer and the radiation source, the engine capable to instruct the source to emit an electromagnetic radiation pulse and to triangulate the position of an ultrasound transponder based on the first elapsed time, the second elapsed time and the known distance between detectors.

18. The position sensing system of claim 17, wherein the first and second ultrasound detectors detect ultrasound waves having a frequency of between about 40 KHz to 100 KHz.

19. The position sensing system of claim 17, wherein the electromagnetic pulses are infrared.

20. The position sensing system of claim 17, wherein the electromagnetic pulses are in radio frequency.

21. The position sensing system of claim 17, wherein the timer includes a first counter capable to measure the first elapsed time, and wherein the timer further includes a second counter capable to measure the second elapsed time.

22. The position sensing system of claim 17, further comprising a digital ink generation engine capable to display positions of the transponder over time.

23. The position sensing system of claim 17, further comprising a character generation engine capable to generate characters based on a series of triangulation data calculated by the triangulation engine.

24. The position sensing system of claim 17, wherein the timer has a clock rate of at least about 1 MHz.

25. The position sensing system of claim 17, wherein the triangulation engine is further capable to instruct the radiation source to emit a data mode electromagnetic pulse to the transponder.

26. The position sensing system of claim 25, wherein the triangulation engine is further capable to receive data stored in the transponder after sending the data mode pulse.

27. The position sensing system of claim 26, wherein the triangulation engine is further capable to verify the received data.

28. The position sensing system of claim 27, wherein the triangulation engine verifies the received data using a checksum algorithm.

29. A method, comprising:
(a) emitting an electromagnetic radiation pulse;
(b) detecting receipt of an ultrasound compression wave from a transponder at a first and a second location;
(c) determining a first elapsed time between emission of the pulse and detection of the wave at the first location;
(d) determining a second elapsed time between emission of the pulse and detection of the wave at the second location;
(e) triangulating the transponder based on the first elapsed time, the second elapsed time, and a known distance between the first and second locations.

30. The method of claim 29, wherein the ultrasound compression wave has a frequency of between about 40 KHz to 100 KHz.

31. The method of claim 29, wherein electromagnetic radiation pulse is Infrared.

32. The method of claim 29, wherein electromagnetic radiation pulse includes radio frequency.

33. The method of claim 29, further comprising:
repeating (a)-(e) a plurality of times to generate a set of triangulation data; and
generating digital ink based on the set of triangulation data.

34. A position sensing system, comprising:
means for emitting an electromagnetic radiation pulse;
means for detecting receipt of an ultrasound compression wave from a transponder at a first and a second location;
means for determining a first elapsed time between emission of the pulse and detection of the wave at the first location;
means for determining a second elapsed time between emission of the pulse and detection of the wave at the second location;
means for triangulating the transponder based on the first elapsed time, the second elapsed time, and a known distance between the first and second locations.

35. A transponder, comprising:
an electromagnetic radiation detector;
an ultrasound generator coupled to the detector capable to send an ultrasound compression wave when the detector detects an electromagnetic pulse; and
a data mode detector coupled to the radiation detector and generator, the data mode detector capable to detect a signal to transmit data stored in the transponder, the data mode detector further capable to instruct the ultrasound generator to transmit the stored data.

36. The transponder of claim 35, further comprising a switch coupled to the detector and transducer, the switch capable to control operation of the detector.

37. The transponder of claim 36, wherein the switch is actuated by pressure.

38. The transponder of claim 36, wherein the switch is actuated by heat.

39. The transponder of claim 36, wherein the switch is actuated by tilt of the transponder.

40. The transponder of claim 35, wherein the transponder is disposed within a stylus.

41. The transponder of claim 35, wherein the electromagnetic radiation detector detects infrared radiation.

42. The transponder of claim 35, wherein the ultrasound compression wave has a frequency of between about 40 KHz and 100 KHz.

43. The transponder of claim 35, further comprising a light pipe coupled to the detector.

44. The transponder of claim 35, wherein the stored data is financial data that, when transmitted, enables a financial transaction.

45. The transponder of claim 35, wherein the stored data, when transmitted, is capable to enable a device.
